(19) United States
(12) Patent Application Publication
(10) Pub. No.: US 2009/0111446 A1
(43) Pub. Date: Apr. 30, 2009

(54) CellPhone Answering System Without Button or Flip Event

(75) Inventors: Frank Cui, Round Lake, IL (US); George Ge, Nanjing (CN); Leyan Xu, San Diego, CA (US)

Correspondence Address: Jon P. Christensen;Welsh & Katz Ltd., 22nd Flr, 120 S. Riverside Plaza, Chicago, IL, 60606, US

(73) Assignee: Motorola Inc., Schaumburg, IL (US)

(21) Appl. No.: 11/931,354

(22) Filed: Oct. 31, 2007

(51) Int. Cl. H04M 3/00; H04M 1/00

(52) U.S. Cl. 455/418; 455/567

(57) ABSTRACT

A method and apparatus for operating a cellular telephone are provided. The method includes the steps of detecting a call, monitoring a sensor that detects performance of a predetermined act by a user and activating the cellular telephone to accept the detected call when the monitored sensor changes state in response to performance of the predetermined act.

### FIELD OF THE INVENTION

The field of the invention relates to cellular telephones and more particularly to methods of accepting cellular telephone calls.

### BACKGROUND OF THE INVENTION

Cellular telephones have become an almost indispensable fact of life. Nothing is able to offer the mobility that cellular telephones provide.

Moreover, most cellular telephones provide a user interface that is easy to use. Typically the user interface includes a keyboard for entry of dialed number and a display screen showing a menu of possible options.

In order to place a call, a user may simply activate the cellular telephone and enter a destination telephone number. The user may then activate a send button.

When the cellular telephone is activated, the cellular telephone automatically begins searching for a local base station. In order to facilitate the search for a base station, the base stations may transmit identification messages on one or more control channels. In order to locate a control channel of a local base station, the cellular telephone may scan a series of channels by individually stopping on each channel and decoding any information on the channel in an effort to determine if a currently scanned channel is a control channel of a local base station.

Once the cellular telephone locates a control channel, the cellular telephone may register its presence with the base station. Once registered, the cellular telephone may remain tuned to the control channel to place outgoing or to receive incoming calls.

In the case of an outgoing call, entry of a destination telephone number and activation of the send button causes the cellular telephone to transmit the destination telephone to the local base station. The base station may complete the connection and the user and called party may begin conversing.

In the case of incoming calls, the base station may transmit a call alert message to the cellular telephone including an identifier of the call phone and, possibly, an identifier of the caller. The cellular telephone may decode the alert and cause the cellular telephone to being ringing. To answer the call, the user may activate a call accept button on the cellular telephone and begin conversing.

While the user interface on cellular telephones is relatively simple to use, there are times where the interface is an impediment to easy use. Accordingly, a need exists for greater simplification of the cellular telephone interface.

### SUMMARY

A method and apparatus for operating a cellular telephone are provided. The method includes the steps of detecting a call, monitoring a sensor that detects performance of a predetermined act by a user and activating the cellular telephone to accept the detected call when the monitored sensor changes state in response to performance of the predetermined act.

In another aspect, the method the predetermined act includes the user placing the cellular telephone against the user's head.

In another aspect, the method includes disposing the sensor adjacent a microphone of the cellular telephone.

In another aspect, the method includes disposing the sensor adjacent a speaker of the cellular telephone.

In another aspect, the monitored sensor further includes a temperature sensor.

In another aspect, the change in state further includes the detected temperature exceeding a threshold value.

In another aspect, the threshold value is 96 degrees.

In another aspect, the threshold value is a predetermined temperature change.

In another aspect, a cellular telephone is provided. The cellular telephone includes a radio frequency receiver that detects an incoming call, a sensor that detects a user placing the cellular telephone against the user's head and a controller that activates the cellular telephone to accept the detected call when the sensor detects the user.

In another aspect, the sensor is a thermally activated switch.

In another aspect, the sensor is a thermocouple.

In another aspect, the sensor is an infrared detector.

In another alternate aspect, the cellular telephone includes a call detector that detects an incoming call, a sensor that changes state in response to a user performing a predetermined act and a controller that activates the cellular telephone to accept the detected call when the sensor changes state.

In another aspect, the monitored sensor is a touch sensor.

In another aspect, the monitored sensor is a pair of touch sensors.

In another alternate aspect, the cellular telephone includes means for detecting a call, means for detecting a user performing a predetermined act and means for activating the cellular telephone to accept the detected call when the means for detecting detects the user.

In still another alternate aspect, the cellular telephone includes a call detector that detects an incoming call, a thermal sensor that detects a user performing a predetermined act and a controller that activates the cellular telephone to accept the detected call when the thermal sensor detects the user.

### BRIEF DESCRIPTION OF THE DRAWINGS

FIG. 1 is a block diagram of a cellular telephone in accordance with an illustrated embodiment of the invention; and

FIG. 2 depicts a sensor used by the cellular telephone of FIG. 1.

### DETAILED DESCRIPTION OF AN ILLUSTRATED EMBODIMENT

In order to accept a cellular telephone call, a user is required to perform some predetermined step with regard to a user interface of the cellular telephone. In some cases, the user is required to activate a call accept softkey on a display screen or activate a button on a keyboard. In other designs, the user is required to flip open a front cover of the cellular telephone or move a sliding cover to an operational position in order to accept the call.

While the activation of a softkey on a display or button on a keyboard or flipping or sliding open a cover is not overly burdensome for a person at rest, these activities can be difficult or even dangerous for a person doing other things such as walking, running or even driving a car. In any of these cases, the selection of a button or softkey requires that the user focus their eyes on the cellular telephone in order to place there hand over and ultimately activate the button with their finger. Similarly, but less so, the flipping or sliding a cover to an open state requires a certain amount of dexterity that may distract the user from his/her previous activity.

Even if the user is able to safely divert his/her attention from their previous activity for a short period, the user may still not succeed in answering the call. For example, there is still a high probability that the user to inadvertently press the wrong button or perform some other unfavorable action that results in a missed call.

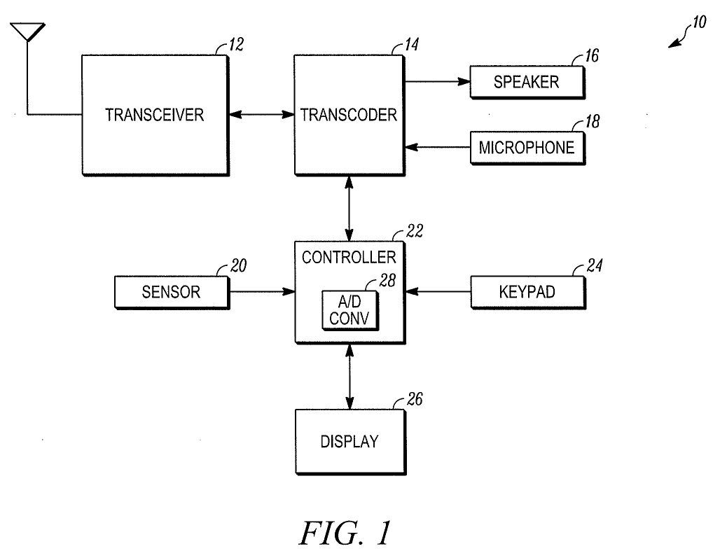

FIG. 1 is a block diagram of a cellular telephone 10 that avoids these problems, shown generally in accordance with an illustrated embodiment of the invention. The cellular telephone 10 may include a radio frequency (rf) transceiver 12, a transcoder 14, a speaker 16, a microphone 18, a sensor 20, a controller 22, a keypad 24 and an interactive display 26. The rf transceiver 12, the transcoder 14, the speaker 16, the microphone 18, the keypad 24 and display 24 may be conventional.

To place a call, the user may activate the cellular phone 10 and enter a telephone number of a call destination through the keypad 24. In order to place the call, the rf transceiver 12 may scan a frequency spectrum for a control channel. The rf transceiver 12 may transfer any detected signals to the transcoder 14 where an information content of the signals is retrieved and sent to the controller 22.

Once the controller 22 scan for and identifies a base station (not shown), the controller 22 may compose a call request message and sent the message to the base station. The base station may decode the call request, verify that the cellular telephone 10 is authorized to operate through the base station and assign a subscriber channel for use by the cellular telephone 10 for the duration of the call. The base station may also set up a communication channel (e.g., a landline) to the call destination. The cellular telephone 10 may move to the assigned channel and the user may begin to converse.

To a certain extent, incoming calls from callers to the cellular telephone 10 may also be handled conventionally. Upon activation, the cellular telephone 10 may register is presence with a local base station. When another party places a call to the cellular telephone 10, the base station may send a call alert message to the cellular telephone 10.

The rf transceiver 12 may receive the call alert and transfer the alert to the transcoder 14 where the message is decoded and sent to the controller 22. The controller 22 may detect that the message is for an incoming call. In response, the controller 22 may cause an alerting device to begin generating an alert to the user. The alert may be a set of audible ring tones generated through use of the speaker 16.

Under one illustrated embodiment, the cellular telephone 10 is provided with a sensor that automatically detects the user performing some predetermined act in confirmation of acceptance of the call. The predetermined act that signals acceptance by the user of the incoming call may involve the simple act of the user placing the cellular telephone 10 against the side of their head to begin conversing. Once the sensor 20 has detected the predetermined act, the controller 22 automatically composes a call acceptance message for transmission to the base station. The base station receives the message, assigns a voice channel, the cellular telephone 10 tunes to the assigned channel and the user and caller begin conversing.

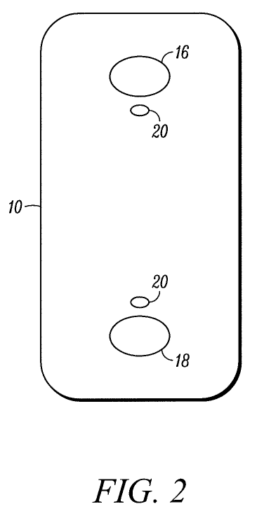

The sensor 20 may detect the predetermined act using any of a number of different methodologies. For example, the sensor 20 may be a temperature or thermo sensor or switch 20 located adjacent the speaker 16 or microphone 18 as shown in FIG. 2. In this case, when the user places the cellular telephone 10 against the side of the user's head, the speaker 16 is placed against the user's ear and the microphone 18 is placed adjacent or against the user's mouth. In either case, the temperature sensor 20 detects a temperature change from ambient to a temperature close to that of the human body.

The sensor 20 may be a thermocouple or a resistive element with a known resistance change per degree of temperature change. In this case, an analog to digital converter 28 associated with the controller 22 may measure an output of the sensor 20.

In use, the controller 22 only activates the sensor 20 when an incoming call is detected. Once a call is detected, the controller 22 begins monitoring the sensor for a detected temperature. Detection of the user may be based upon a temperature threshold value (e.g., 96° F.) or based upon some threshold temperature change (e.g., 10° F.) over a predetermined time period (e.g., 1 second). Once call acceptance is detected, the controller 22 may deactivate the sensor 20 and the call may proceed conventionally.

In another illustrated embodiment, the sensor 20 may be an infrared (IR) transmitter/receiver (transceiver) combination. In this case, the IR transmitter may transmit a beam towards the ear of a user. The receiver may detect a beam reflected from the ear or face of the user to detect acceptance of the call.

In another illustrated embodiment, the sensor 20 may be an ultrasonic transceiver combination. In this case, the ultrasonic transmitter transmits an ultrasonic wave that is reflected from the face of the user. The receiver detects the ultrasonic sound wave reflected by the head of the user to detect acceptance of the call.

In another embodiment, the controller 22 may begin monitoring the microphone 18 after an incoming call is detected. In this case the predetermined act may be the user uttering some sound (e.g., HELLO) into the microphone. In this case, the detected sound may be compared with a threshold value to detect acceptance of the call.

In still another embodiment, the sensor 20 may be a pair of touch sensors located so that they would be simultaneously activated only when the user would choose to signal acceptance of the call. The sensors would be located adjacent the speaker 16 and microphone 18 as shown in FIG. 2 so that when the user touches his/her ear to the speaker 16 and lips to the microphone 18, the cellular telephone 10 becomes active.

A specific embodiment of method and apparatus for activating a cellular telephone has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of operating a cellular telephone comprising:
detecting a call;
monitoring a sensor that detects performance of a predetermined act by a user; and
activating the cellular telephone to accept the detected call when the monitored sensor changes state in response to performance of the predetermined act.

2. The method of operating the cellular telephone as in claim 1 wherein the predetermined act further comprises the user placing the cellular telephone against the user's head.

3. The method of operating the cellular telephone as in claim 1 further comprising disposing the sensor adjacent a microphone of the cellular telephone.

4. The method of operating the cellular telephone as in claim 1 further comprising disposing the sensor adjacent a speaker of the cellular telephone.

5. The method of operating the cellular telephone as in claim 1 wherein the monitored sensor further comprises a temperature sensor.

6. The method of operating the cellular telephone as in claim 5 wherein the change in state further comprises the detected temperature exceeding a threshold value.

7. The method of operating the cellular telephone as in claim 7 wherein the threshold value further comprises 96 degrees.

8. The method of operating the cellular telephone as in claim 5 wherein the threshold value further comprises a predetermined temperature change.

9. A cellular telephone comprising:
a radio frequency receiver that detects an incoming call;
a sensor that detects a user placing the cellular telephone against the user's head; and
a controller that activates the cellular telephone to accept the detected call when the sensor detects the user.

10. The cellular telephone as in claim 9 wherein the sensor further comprises a thermally activated switch.

11. The cellular telephone as in claim 9 wherein the sensor further comprises a thermocouple.

12. The cellular telephone as in claim 9 wherein the sensor further comprises an infrared detector.

13. A cellular telephone comprising:
a call detector that detects an incoming call;
a sensor that changes state in response to a user performing a predetermined act; and
a controller that activates the cellular telephone to accept the detected call when the sensor changes state.

14. The cellular telephone as in claim 13 wherein the predetermined act further comprises the user placing the cellular telephone against the user's head.

15. The method of operating the cellular telephone as in claim 12 wherein the monitored sensor further comprises a touch sensor.

16. The method of operating the cellular telephone as in claim 13 wherein the monitored sensor further comprises a pair of touch sensors.

17. The method of operating the cellular telephone as in claim 13 wherein the monitored sensor further comprises a thermal sensor.

18. A cellular telephone comprising:
means for detecting a call;
means for detecting a user performing a predetermined act; and
means for activating the cellular telephone to accept the detected call when the means for detecting detects the user.

19. The method of operating the cellular telephone as in claim 18 wherein the means for detecting further comprises a temperature sensor.

20. The method of operating the cellular telephone as in claim 19 further comprising the temperature sensor disposed adjacent a microphone of the cellular telephone.

21. The method of operating the cellular telephone as in claim 19 further comprising the temperature sensor disposed adjacent a speaker of the cellular telephone.

22. A cellular telephone comprising:
a call detector that detects an incoming call;
a thermal sensor that detects a user performing a predetermined act; and
a controller that activates the cellular telephone to accept the detected call when the thermal sensor detects the user.

23. The cellular telephone as in claim 22 wherein the predetermined act further comprises the user placing the cellular telephone against the user's head.

24. The method of operating the cellular telephone as in claim 22 further comprising the thermal sensor disposed adjacent a microphone of the cellular telephone.

25. The method of operating the cellular telephone as in claim 22 further comprising the temperature sensor disposed adjacent a speaker of the cellular telephone.
